(19) United States
(12) Patent Application Publication
(10) Pub. No.: US 2015/0335504 A1
(43) Pub. Date: Nov. 26, 2015

(54) Chair-Men Leverage Assistance For Any Lift Chair

(71) Applicant: Jay Howard Meyer, Long Rd, NY (US)

(72) Inventor: Jay Howard Meyer, Long Rd, NY (US)

(21) Appl. No.: 14/282,969

(22) Filed: May 20, 2014

(51) Int. Cl. A61G 5/14; A61G 5/10

(52) U.S. Cl. CPC A61G 5/14; A61G 5/107

(57) ABSTRACT

“The Chair-Men” is a device not currently available when purchasing a lift chair for someone requiring additional assistance when exiting or returning to the chair. The lift chair creates a slippery non-level armrest surface when the chair is raised to the inclined upward position. “The Chair-Men” provides additional leverage to the user via its angle shape. This angle creates a level plane and solid base for the user to grip and push-off when exiting the lift chair.

### 1) BACKGROUND

The typical lift chair tilts the user approx 40 degrees. The user must still push-off using their arm strength to obtain a vertical standing position. The point of leverage is the tilted or inclined armrest. Often the armrest fabric or covering is too slippery for adequate grip adding to this lack of leverage. The use of “The Chair-Men” attachments, re-establishes a near level plane or leverage point and easy push-off for the user.

2) Materials: Materials are shown on the drawing in the bill of materials. Further described as follows:
Upholstered Block: Any solid material which allows drilling of screw holes, e.g.: wood, plastic, etc. The blocks can be covered with matching fabric of the chair.
Angle base: 18 gauge or similar thickness carbon steel formed into a 90 degree angle and drilled with the required screw holes.
Screws: Common wood or metal screws, depending on chair armrest construction.

3) Installation: Once a comfortable position is determined with the user seated in the chair, the angle blocks are positioned with the vertical upright portion farthest from the user and shall be secured to the chair's armrests via the screws. One angle block per armrest. Then the upholstered blocks can be secured to the angle blocks via the screws.

### SUMMARY OF THE INVENTION

“The Chair-Men” provide better leverage and grip to the user when exiting the lift chair.

### DESCRIPTION OF DRAWING VIEWS

FIG. 1: This view depicts the user in the chair in the lifted position and pushing-off using the Chair-Men.

FIG. 2: This view depicts the upholstered block. The block can be wood or plastic. It can be upholstered with matching fabric of the chair, vinyl, leather or other fabric. Covering fabric is secured using contact cement or rubber cement.

FIG. 3: This view depicts the angle base. The angle base is formed into a 90 degree angle in a press brake and screw holes are drilled. The angle base is to be painted black or a color matching the chair fabric.

FIG. 4: This view depicts the insertion of screws. Three into the chair armrest and two into the upholstered block, in that order. Predrilled pilot holes are recommended to prevent splitting of the armrest support material, which is typically hardwood.

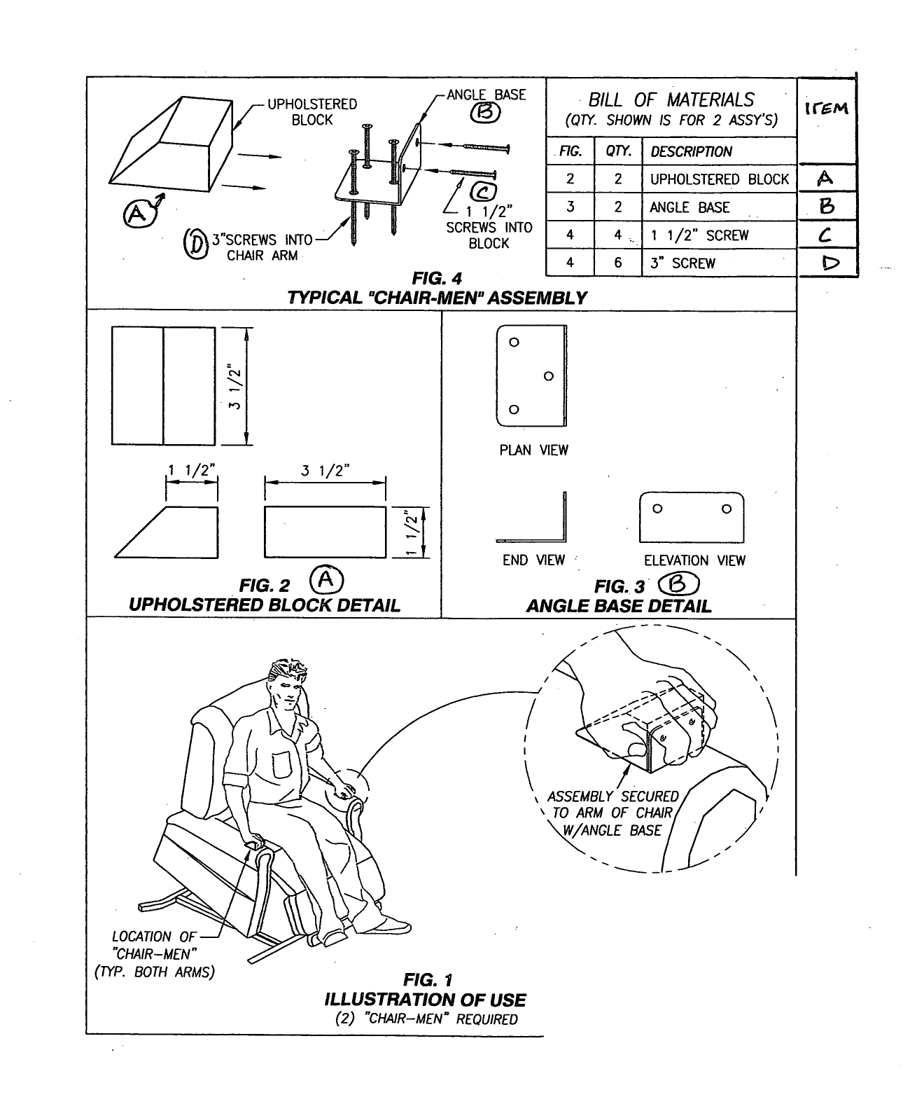

### DETAILED DESCRIPTION OF THE INVENTION

“The Chair-Men” are leverage assistance devices which can be added to any lift chair. They provide a level plane which allows the user to push-off once the lift chair has reached its desired upward position, approximately 40 degrees inclined. “The Chair-Men” consists of two upholstered blocks, two angle bases to secure the blocks to the chair's armrests and the screws needed for installation. “The Chair-Men” are also used to aid the user when returning to the chair, providing the same level surface to grip and not slide off the armrest.

1. “The Chair-Men” leverage assistance device can be used on any lift chair. They offer the user a solid, slip-free, level surface to grip and push-off when exiting the lift chair.

2. “The Chair-Men” also offer the same benefit when returning to the chair, as to assist in a stable way of re-seating the user.
